(19) United States
(12) Patent Application Publication
(10) Pub. No.: US 2013/0245979 A1
(43) Pub. Date: Sep. 19, 2013

(54) METHOD OF DETERMINATION, INSPECTION APPARATUS, AND INSPECTION SYSTEM

(71) Applicant: TAIYO YUDEN CO., LTD., Tokyo (JP)

(72) Inventor: Hiroya KAKIMOTO, Tokyo (JP)

(73) Assignee: Taiyo Yuden Co., Ltd., Tokyo (JP)

(21) Appl. No.: 13/794,102

(22) Filed: Mar. 11, 2013

(30) Foreign Application Priority Data
Mar. 14, 2012 (JP) 2012-056912

(51) Int. Cl. G01D 18/00

(52) U.S. Cl. CPC G01D 18/00
USPC 702/85

(57) ABSTRACT

One object is to facilitate maintenance of an inspection apparatus for an optical recording disk. In accordance with one aspect, the present method includes: determining whether an inspection apparatus for inspecting recording conditions of an optical recording disk can be further used based on a divergence index correlated to divergence from a state where the inspection apparatus is calibrated or on a difference between the divergence index and a reference value of the divergence index; and, if it is determined that the inspection apparatus can be further used, setting authorization for inspecting the optical recording disk by the inspection apparatus. This method enables inspection of optical recording disks with ensured inspection performance of the inspection apparatus.

### CROSS-REFERENCE TO RELATED APPLICATIONS

This application is based on and claims the benefit of priority from Japanese Patent Application Serial No. 2012-056912 (filed on Mar. 14, 2012), the contents of which are hereby incorporated by reference in its entirety.

### TECHNICAL FIELD

The present invention relates to a technique for maintaining an inspection apparatus for optical recording disks.

### BACKGROUND

In a situation where most archive data was stored in the form of paper, an electronic document law was established on November 2004 and enforced on April 2005, which authorized the storage of documents in the form of electronic document files as well as paper documents, the documents being obliged to be stored under the commercial law (and related laws) and the tax law. Additionally, guidelines such as JIS-Z6017 were presented to oblige the characteristic inspection in the initial recording period and periodic characteristic inspection over the storage period with a standardized inspection apparatus, and storage of the inspection data. However, archiving on optical disks has practically not made much progress.

Japanese Patent Application Publication No. Hei 6-223527 discloses a technique for detecting a fault and a burst error by providing slice levels in RF signal disturbance (e.g., fluctuation of voltage level) caused by flaws in a recording surface and a substrate of an optical disk (e.g., CD-R). Further, Japanese Patent Application Publication No. 2010-97641 discloses a technique for calculating error rate based on fault inspection and comparing the error rate to a threshold value to determine whether data reproduction is possible. Still further, Japanese Patent Application Publication No. 2009-116998 discloses a technique for determining whether copy-restricted contents are available based on fault inspection on a disk using tracking error signals. Yet further, Japanese Patent Application Publication No. Hei 10-246686 discloses a technique for calibrating an inspection apparatus by using a reference disk.

However, these techniques do not include an idea of maintaining the inspection apparatus for the optical recording disks.

### SUMMARY

Accordingly, an object of the present invention in one aspect is to provide a technique for facilitating maintenance of an inspection apparatus for optical recording disks.

The determination method in this aspect comprises the steps of: (A) determining whether an inspection apparatus for inspecting recording conditions of an optical recording disk can be further used based on a divergence index correlated to divergence from a state where the inspection apparatus is calibrated or on a difference between the divergence index and a reference value of the divergence index; and (B) if it is determined that the inspection apparatus can be further used, setting authorization for inspecting the optical recording disk by the inspection apparatus.

The above method enables inspection of optical recording disks with ensured inspection performance of the inspection apparatus.

The determination method may further comprise the steps of: (C) if it is determined that the inspection apparatus cannot be further used, obtaining at least one evaluation index out of error rate, the number of uncorrectable errors, jitter, and asymmetry value from reproduction signals of a reference disk; and (D) if the at least one evaluation index is within a predetermined range, setting authorization for inspecting the optical recording disk by the inspection apparatus. Thus, even when the further use is unauthorized, the inspection can be performed if the inspection performance of the inspection apparatus is practically confirmed from the evaluation index of the reproduction signals.

Additionally, the determining method may further comprise the step of: (E) if the at least one evaluation index is within a predetermined range, initializing the divergence index held in the inspection apparatus. This step eliminates the need of separate calibration and makes it easy to begin the next inspection.

The determination method may further comprise the steps of: (F) if it is determined that the inspection apparatus can be further used, determining whether the divergence index or the difference between the divergence index and the reference value of the divergence index satisfies a predetermined condition before satisfying the condition by which it is determined that the inspection apparatus cannot be further used; (G) if it is determined that the predetermined condition is satisfied, obtaining at least one evaluation index out of error rate, the number of uncorrectable errors, jitter, and asymmetry value from reproduction signals of the optical recording disk; (H) if the at least one evaluation value is within a predetermined range, setting authorization for inspecting the optical recording disk by the inspection apparatus. Thus, the inspection apparatus is not left uninspected until it is determined, based on the divergence index, that the inspection apparatus cannot be further used; and the inspection performance of the inspection apparatus is practically confirmed from the evaluation index of the reproduction signals in advance.

The determination method may further comprise the steps of: (I) if it is determined that the inspection apparatus can be further used, obtaining at least one evaluation index out of error rate, the number of uncorrectable errors, jitter, and asymmetry value from reproduction signals of the optical recording disk; (J) determining recording conditions of the optical recording disk based on the at least one evaluation index and storing a determination result in a data storage unit.

The determination method may further comprise the step of: (K) if it is determined that the inspection apparatus cannot be further used, setting unauthorization for inspecting the optical recording disk by the inspection apparatus. Further, the determination method may further comprise the step of: if it is determined that the inspection apparatus cannot be further used, providing a display on a display device indicating that the inspection apparatus is in a warning state. Furthermore, the determination method may further comprise the step of: if the at least one evaluation index is not within the predetermined range, providing a display on a display device indicating that the inspection apparatus is in a warning state.

Additionally, a program may be created to cause a computer to perform the above processing. This program may be stored on a computer-readable storage medium or storage device, e.g., an optical disk such as a flexible disk and CD-ROM, an magnetic optical disk, a semiconductor memory (e.g., ROM), and a hard disk.

In one aspect, the present invention facilitates maintenance of an inspection apparatus for an optical recording disk.

### BRIEF DESCRIPTION OF THE DRAWINGS

FIG. 1 schematically shows an inspection system.

FIG. 2 is a function block diagram of an inspection apparatus.

FIG. 3 is a function block diagram of a computer.

FIG. 4 shows a main process flow according to Embodiment 1.

FIG. 5 shows a process flow of an inspection process.

FIG. 6 shows thresh levels for error rates.

FIG. 7 shows thresh levels for jitter.

FIG. 8 shows thresh levels for the number of uncorrectable errors.

FIG. 9 shows thresh levels for asymmetry values.

FIG. 10 shows an example of a decision table.

FIG. 11 shows an example of an auxiliary table.

FIG. 12 shows a main process flow according to Embodiment 2.

FIG. 13 is a function block diagram of a computer according to Embodiment 3.

FIG. 14 shows a main process flow according to Embodiment 3.

FIG. 15 is a function block diagram of a computer according to Embodiment 4.

FIG. 16 shows a main process flow according to Embodiment 4.

FIG. 17 shows a main process flow according to Embodiment 4.

FIG. 18 shows a main process flow according to Embodiment 5.

FIG. 19 shows a main process flow according to Embodiment 5.

FIG. 20 shows a main process flow according to Embodiment 6.

FIG. 21 is a function block diagram of a computer.

### DESCRIPTION OF EXAMPLE EMBODIMENTS

### Embodiment 1

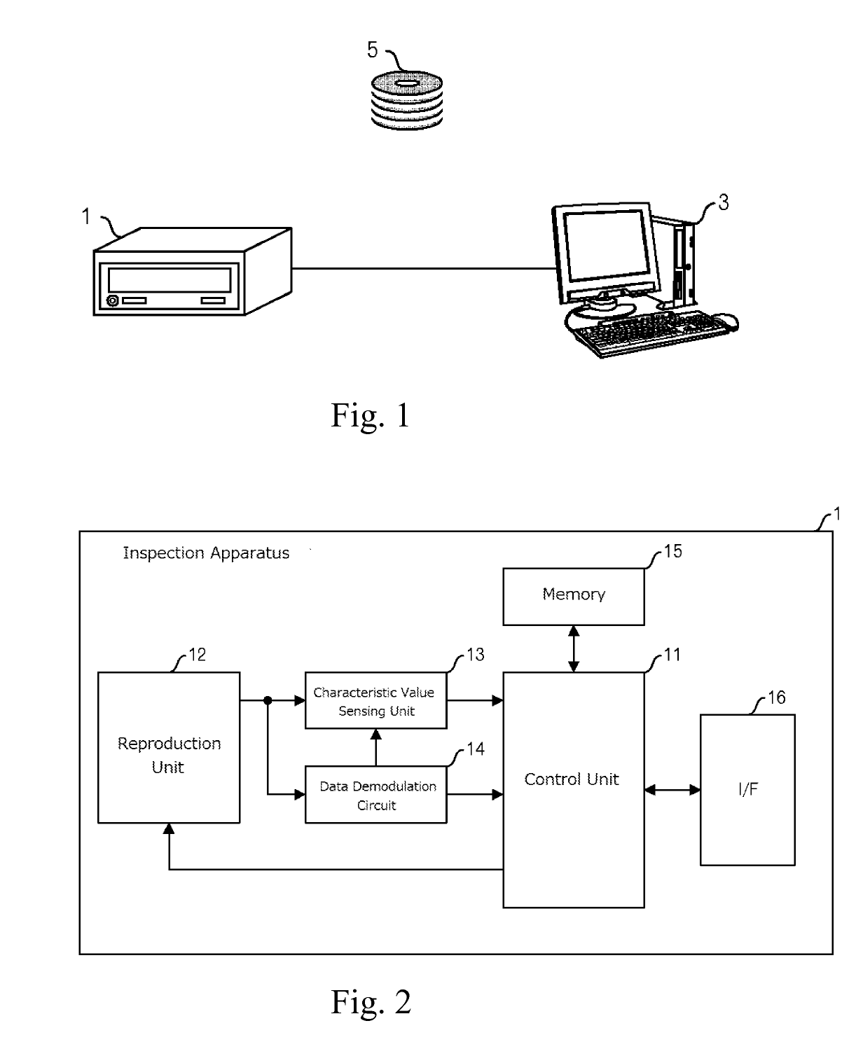

FIG. 1 schematically shows an inspection system according to Embodiment 1. The inspection system according to the embodiment comprises an inspection apparatus 1 including a drive of an optical recording disk 5 and a computer 3 connected to the inspection apparatus 1. The optical recording disk 5 stores document data to be archived.

FIG. 2 schematically shows exemplary constitution of the inspection apparatus 1. The inspection apparatus 1 comprises: a control unit 11 for controlling the inspection apparatus 1 and performing various operations and processes; a reproduction unit 12 for reproducing data stored on the optical disk; a characteristic value sensing unit 13 for sensing various characteristic values from reproduction signals outputted from the reproduction unit 12; a data demodulation circuit 14 for performing data demodulation from the reproduction signals outputted form the reproduction unit 12; a memory 15 for storing data and programs to be used in the control unit 11; and an interface (I/F) 16 for serving as a communication interface to the computer 3. The characteristic value sensing unit 13 senses values to be used for calculating various evaluation indexes described below. The characteristic value sensing unit 13 may use output from the data demodulation circuit 14. The I/F 16 communicates with the computer 3 based on standards such as USB (Universal Serial Bus).

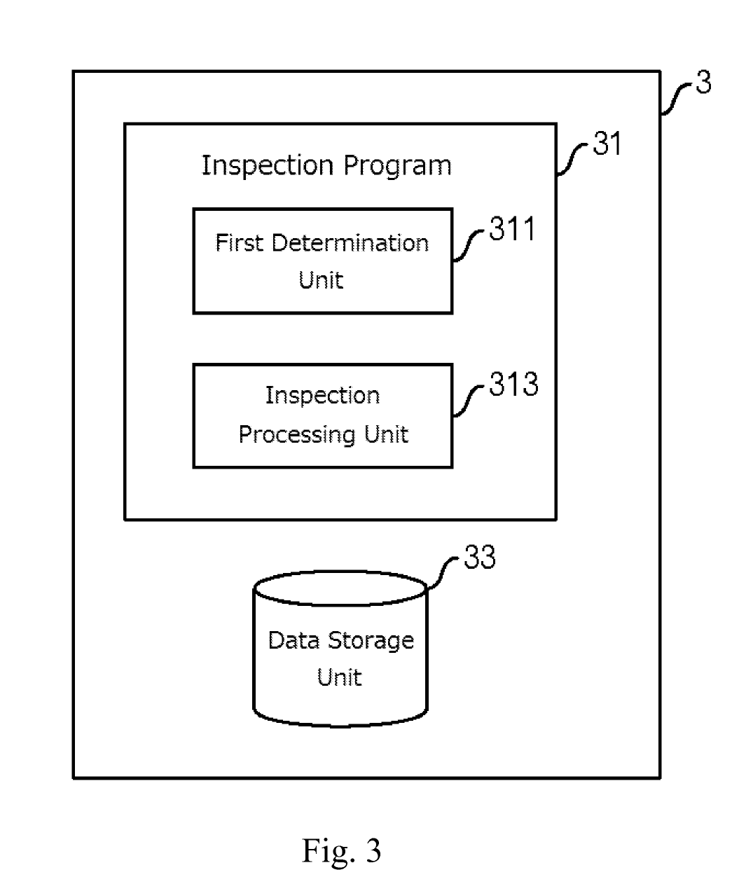

FIG. 3 schematically shows exemplary constitution of the computer 3. The computer 3 runs an inspection program 31 for performing processes according to the embodiment; and the computer 3 comprises a data storage unit 33. When the inspection program 31 is run, a first determination unit 311 and an inspection processing unit 313 are implemented. The first determination unit 311 performs a first determination process to determine whether the inspection apparatus 1 can be further used. The inspection processing unit 313 performs processes of the inspection apparatus 1 related to inspection. In this embodiment, the second determination unit 315 is not used.

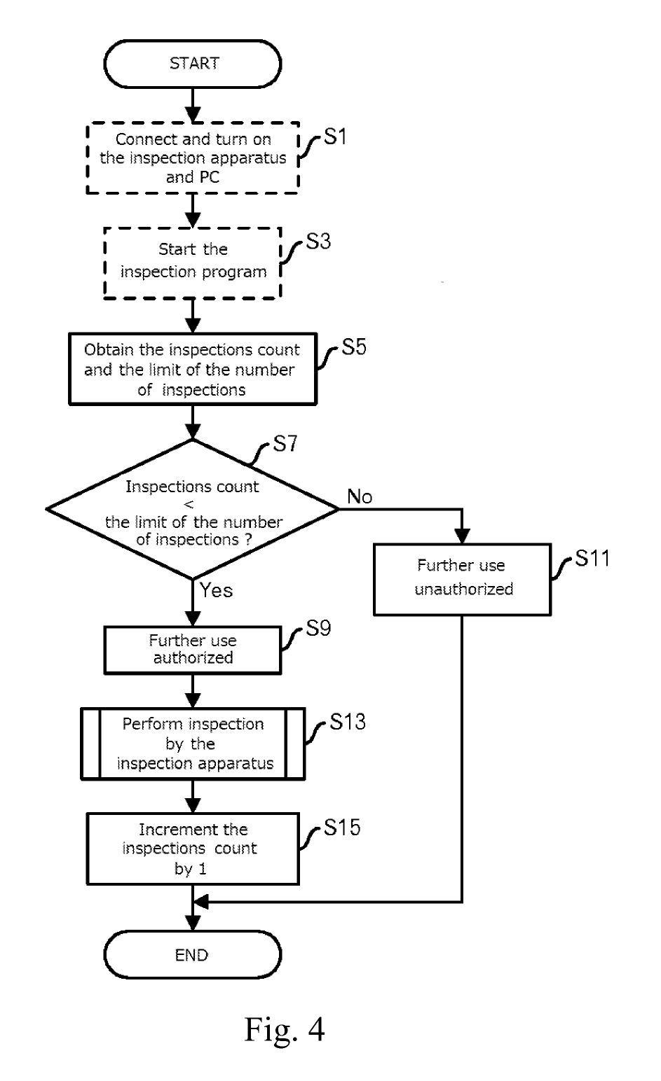

Following is description of the processes of Embodiment 1 with reference to FIGS. 4 to 11. First, a user connects the inspection apparatus 1 and the computer 3 via a USB cable, etc. and turns on the power thereto (FIG. 4: step S1). Operations of the user are shown in dotted blocks.

Then, the user confirms that the inspection apparatus 1 has been detected by the computer 3 and starts the inspection program 31 (step S3). The first determination unit 311 of the started inspection program 31 requests and obtains, from the inspection apparatus 1, the inspections count and the limit of the number of inspections that is used as a reference value for the inspections count (step S5).

In this embodiment, the inspection apparatus 1 may be connected to a different computer 3; therefore, the memory 15 of the inspection apparatus 1 stores the inspections count and the limit of the number of inspections. The limit of the number of inspections may be either variable depending on the type of the inspection apparatus 1 or constant irrespective of the type of the inspection apparatus 1. When the limit of the number of inspections is constant, the limit of the number of inspections may be included in a setting file stored in the data storage unit 33 along with the inspection program 31 and read out from the setting file. The inspections count is an example of divergence indexes correlated to divergence from the state where the inspection apparatus 1 is calibrated; the inspections count may be replaced with, e.g., the power supply period or laser application period of the inspection apparatus 1. Further, the inspections count may be either a value counted and stored in memory 15 by the control unit 11 of the inspection unit 1, or a value incremented from a previous value by the number of inspections by the inspection processing unit 313 of the inspection program 31 and written in the memory 15 via the I/F 16 by the control unit 11. Still further, in step S5, the first determination unit 311 may merely instruct the control unit 11 of the inspection apparatus 1 to practically read out the inspections count and the limit of the number of inspections from the memory 15.

Next, the first determination unit 311 determines whether the inspections count is smaller than the limit of the number of inspections (step S7). This may be performed by the control unit 11.

When the inspections count is equal to or greater than the limit of the number of inspections, the first determination unit 311 determines that the inspection apparatus 1 cannot be further used and provides a display on the display device of the computer 3 (step S11). The processing is then completed. The first determination unit 311 sets the control unit 11 of the inspection apparatus 1 as being unauthorized for further use. Thus, the inspection of the optical disk by the inspection apparatus 1 is prohibited. When the control unit 11 performs step S7, the determination result is notified to the first determination unit 311 and the first determination unit 311 displays the determination result on the display device in response to the notification.

On the other hand, when the inspections count is smaller than the limit of the number of inspections, the first determination unit 311 authorizes the inspection processing unit 313 to further use the inspection apparatus 1 (step S9). That is, the first determination unit 311 sets the control unit 11 of the inspection apparatus 1 and the inspection processing unit 313 as being authorized for further use of the inspection apparatus 1, and provides the display device with a display indicating that the inspection apparatus 1 can be further used. When the control unit 11 performs step S7, the determination result is notified to the first determination unit 311, and the first determination unit 311 provides a display on the display device in response to the notification. The first determination unit 311 authorizes the inspection processing unit 313 to further use the inspection apparatus 1.

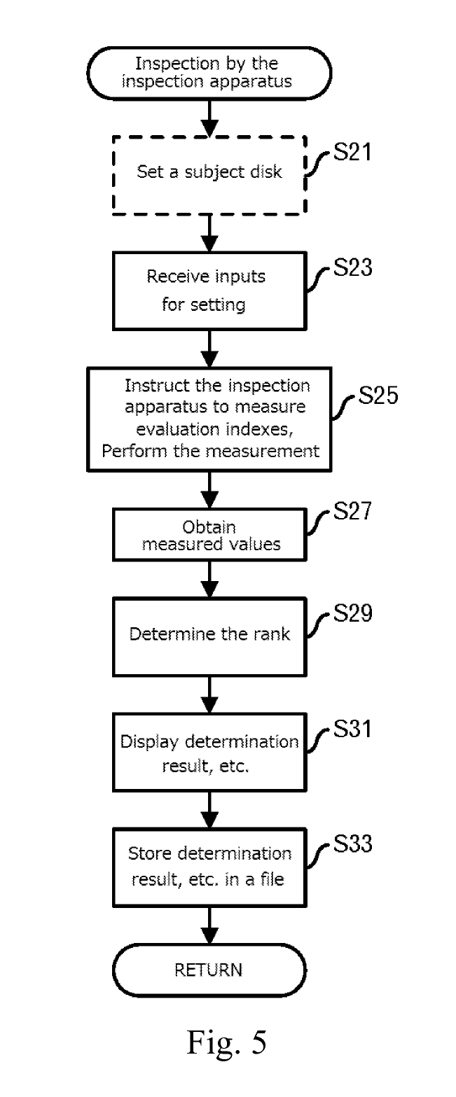

Then, the inspection processing unit 313 performs inspection of the optical recording disk 5 by the inspection apparatus 1 in cooperation with the control unit 11 (step S13). The step S13 will be described in detail with reference to FIGS. 5 to 11.

The control unit 11, which performs processing for inspection in response to instructions from the inspection processing unit 313, increments the inspections count by 1 and stores the inspections count in the memory 15 (step S15). The processing is then completed.

Thus, the optical disk on which archive data is stored is inspected while ensuring that the inspection apparatus is not largely diverged from the calibrated state.

Following is description of the process of step S13 with reference to FIGS. 5 to 11.

First, the user sets the disk to be inspected into the inspection apparatus 1 (FIG. 5: step S21). The inspection processing unit 313 prompts the user to input the storage file name of the measurement result, the name of the disk to be inspected, and other settings and receives and stores input of these data from the user (step S23). Then, the inspection processing unit 313 instructs the inspection apparatus 1 to measure evaluation indexes representing recording characteristics of the disk to be inspected. In response to this instruction, the control unit 11 of the inspection apparatus 1 measures characteristic values on the entire surface of data storage area of the subject disk (step S25).

The measured characteristic values include at least any one of, for example, error rate, the number of uncorrectable errors, jitter, and asymmetry value. That is, the control unit 11 calculates these values by using data from the characteristic value sensing unit 13 and the data demodulation circuit 14. More specifically, either any or all of the maximum value, the minimum value, and the average of these characteristic values are calculated. Preferably, the asymmetry value should be calculated to obtain the maximum value and the minimum value, and the other characteristic values should be calculated to obtain the maximum value.

The control unit 11 outputs these measurement values to the inspection processing unit 313; and the inspection processing unit 313 obtains these measurement values (step S27).

Then, the inspection processing unit 313 performs a rank determination process for the recording characteristics of the subject disk by using a decision table stored on the data storage unit 33 and the obtained measurement values (step S29). This step may also be performed by the control unit 11 of the inspection apparatus 1.

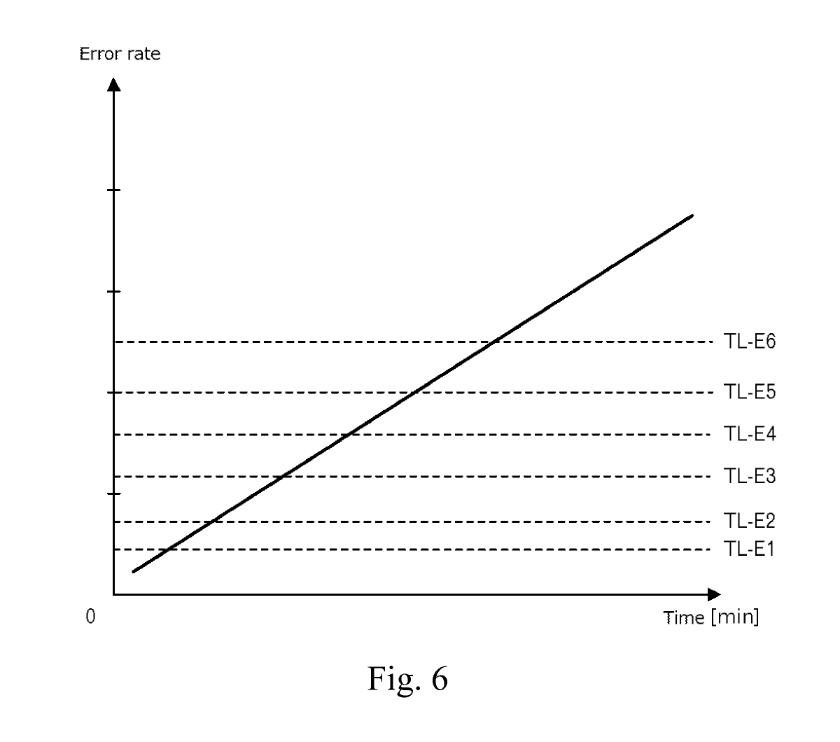

The rank determination process is performed based on, e.g., the time variation of deterioration as shown in FIGS. 6 to 9. That is, FIG. 6 shows an example of time variation of error rate, wherein the error rate linearly increases with elapsed time. Also, FIG. 6 contains six thresh levels TL-E1 to TL-E6.

The six levels are mere examples and can be desirably provided. The thresh level defining the highest quality area (i.e., TL-E1 in FIG. 6) should preferably be attained in the initial recording period. The thresh level defining the lowest quality area (i.e., TL-E6 in FIG. 6) should preferably be used as the upper limit of the standard or the reproduction limit of the recorded data.

Simultaneously, one or more medium thresh levels (TL-E2 to TL-E5 in FIG. 6) should preferably be provided stepwise (not necessarily with regular intervals) between the thresh level defining the highest quality area and the thresh level defining the lowest quality area. This enables accurate grasp of variation tendency of the recording characteristics and the margin to the thresh level defining the lowest quality area.

The intervals between the medium thresh levels are determined based on the measurement accuracy (resolution performance) of the inspection apparatus 1. This is because detailed settings beyond the measurement accuracy are lost in the variation and produce no effect. Further, when the thresh level defining the lowest quality area is used as the reproduction limit of the recorded data, the upper limit of the standard should preferably be set at one of the medium thresh levels. This enables classification of recording characteristics of the subject medium into, e.g., a level conforming to the standard, a level exceeding the standard value but acceptable for practical use, and a level urgently requiring data transfer (i.e., migration).

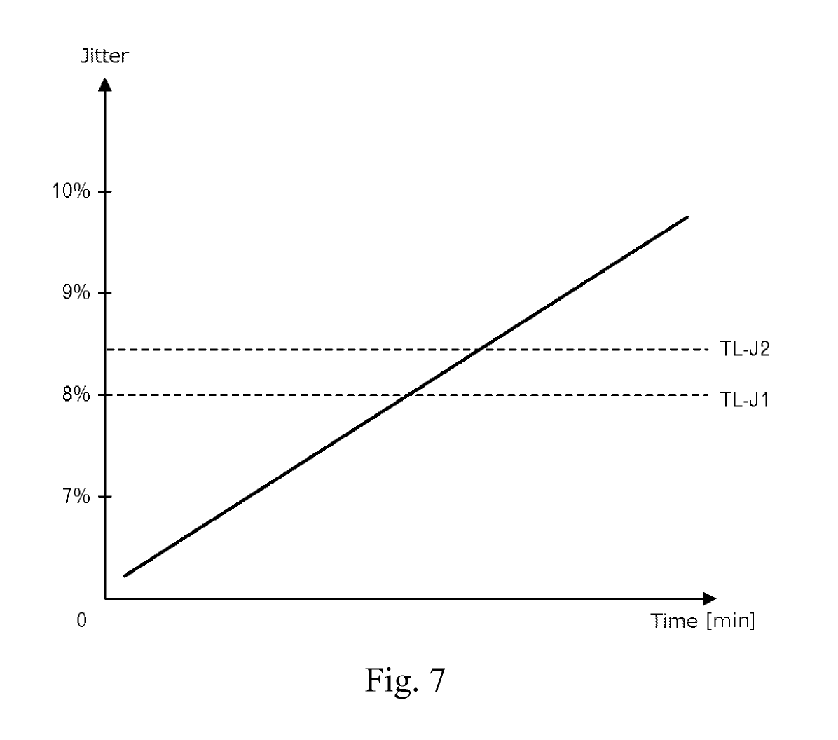

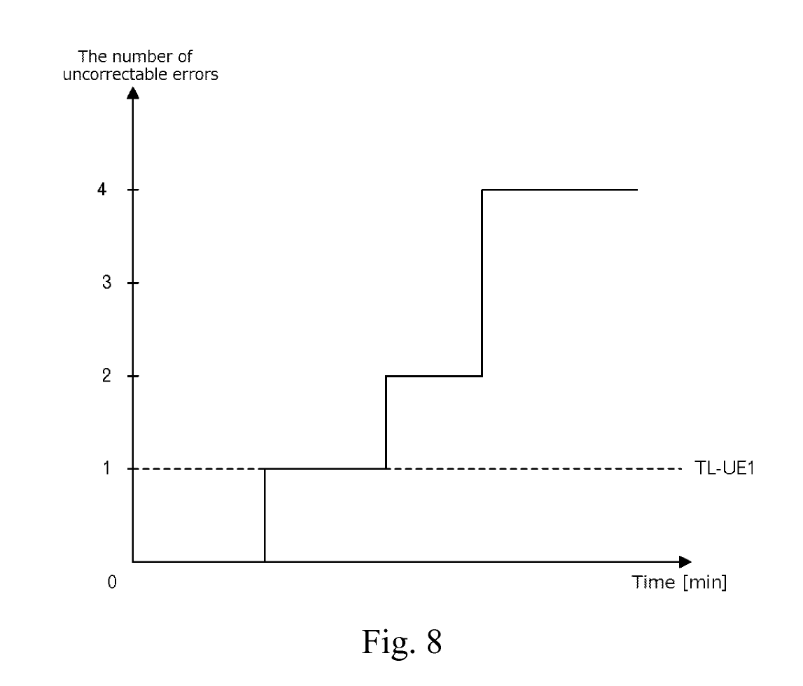

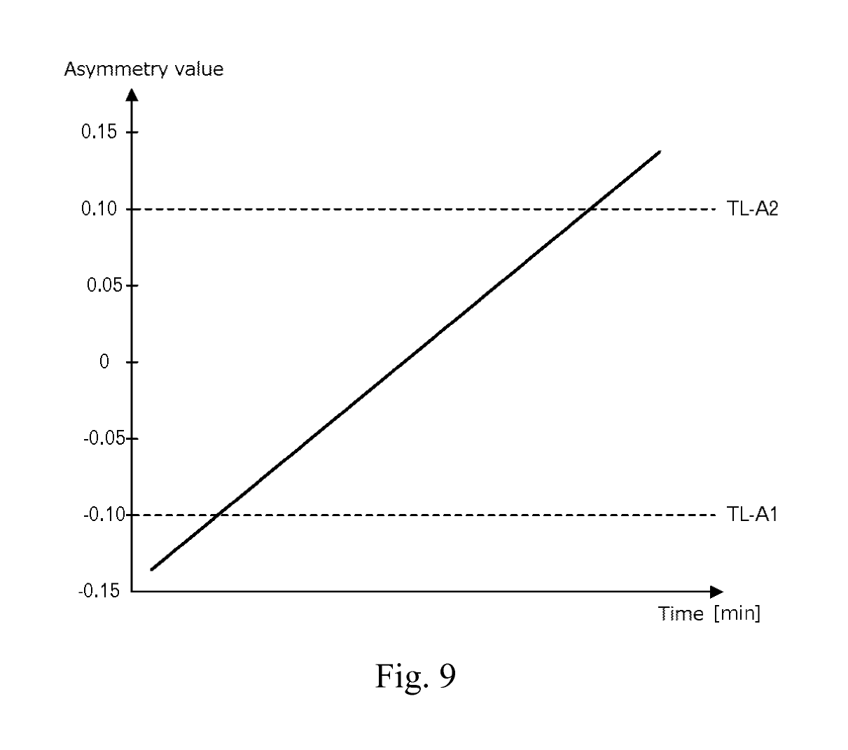

Thresh levels may be set for evaluation indexes such as jitter, the number of uncorrectable errors, and asymmetry value, in addition to error rate. FIG. 7 shows an example of time variation of jitter along with examples of thresh levels; FIG. 8 shows an example of time variation of the number of uncorrectable errors along with examples of thresh levels; and FIG. 9 shows an example of time variation of asymmetry value along with examples of thresh levels; For example, it is preferable to use at least one of error rate, jitter, the number of uncorrectable errors, and asymmetry value combined with one another using relations AND and OR. The setting of thresh levels should not be arbitrarily changed by a user, such that the consistency with the past data can be retained.

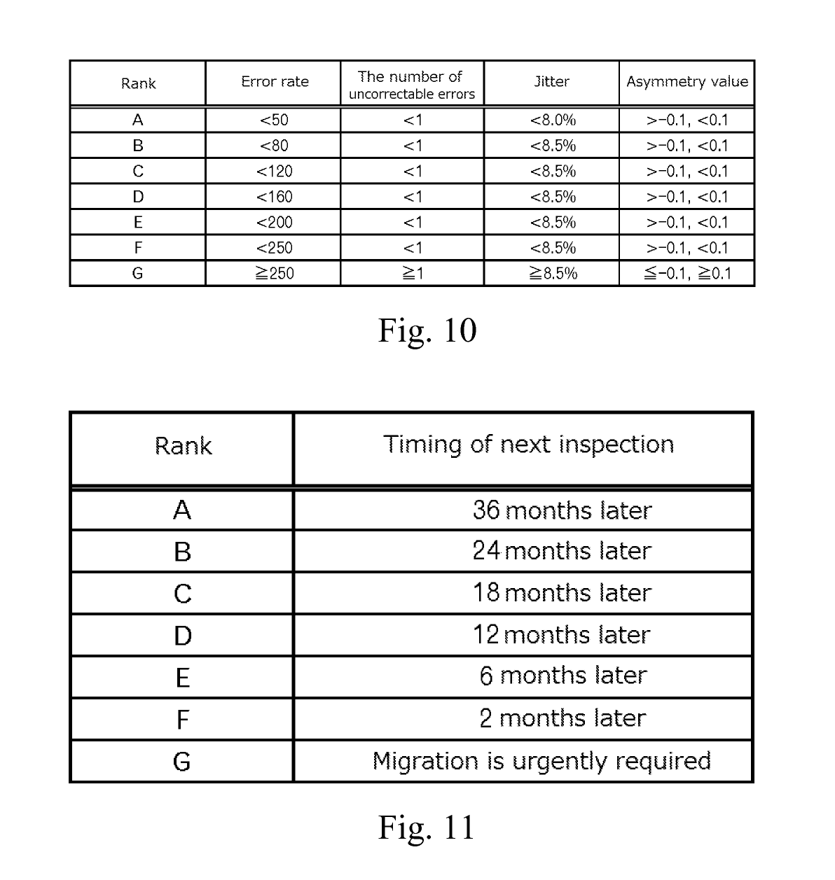

Further, a decision table as shown in FIG. 10 is prepared. The decision table is used to determine the rank of the recording characteristic of the subject disk based on the relationship between the combination of thresh levels set for each evaluation index and the obtained measurement values of the recording characteristic. FIG. 10 shows an example containing seven ranks, each having a corresponding thresh level (i.e., condition) for each evaluation index. In this example, rank G requires any one of the conditions to be satisfied, and the other ranks require all the conditions to be satisfied.

The example shown in FIG. 10 combines four evaluation indexes: error rate, jitter, the number of uncorrectable errors, and asymmetry value. This example is not limitative and may be modified so as to use any one or combine more than one of the four evaluation indexes for determination. However, it is not desirable to use, for determination, a single evaluation index such as the number of uncorrectable errors designated to be “zero” or “one or more” or an asymmetry value with large allowable margin. Such an evaluation index should be used in combination with one or both of error rate and jitter. Additionally, a desired number of ranks can be provided. Further, the listed thresh levels for each rank are mere examples and can be modified in accordance with required specifications and standard levels.

Such a decision table may be stored in the data storage unit 33 of the computer 3 in the form of a file, etc. or stored in the memory 15 of the inspection apparatus 1.

Further, the decision table is related to an auxiliary table as shown in FIG. 11. The auxiliary table in FIG. 11 lists the timing of the next inspection for each rank. In the example shown in FIG. 11, the timing of the next inspection is obtained in accordance with a determined rank. Ranks corresponding to higher quality recording conditions are assigned longer intervals to the timing of the next inspection.

In the example, the longest interval to the timing of the next inspection is 36 months; but this is not limitative and can be modified properly in accordance with the standard of the subject optical disk and the long term reliability data.

In this embodiment, the timing of the next inspection corresponding to the determined rank is also specified based on the auxiliary table. The auxiliary table may also be stored in the data storage unit 33 of the computer 3 in the form of a file, etc. or stored in the memory 15 of the inspection apparatus 1. This may be performed by either the inspection processing unit 313 or the control unit 11.

When the control unit 11 performs step S29, the determination result is notified to the inspection processing unit 313.

Subsequently, the inspection processing unit 313 displays, on the display device, the determination result including data of the rank and the timing of the next inspection (step S31). This enables the user to confirm the current recording conditions of the optical disk and determine when to perform the next inspection. If the migration is urgently required, the user can do it at once; thus, a critical problem such as loss of data can be prevented. Additionally, the measurement values may be displayed along or displayed in response to a request.

The inspection processing unit 313 stores, in the data storage unit 33, data including the measurement values and the determined ranks, the name of the subject optical disk, and the timing of the next inspection in the form of a file having the designated storage file name (step S33). The data for the same subject optical disk may be appended to the same file, so that inspection history can be later checked sequentially for long term inspection data management. Then, the processing returns to the invoker.

Such processing enables proper checking of recording state of an optical disk having recorded thereon archive data for long term storage, by using the inspection apparatus 1 that enables proper inspection.

### Embodiment 2

Embodiment 1 uses indexes such as inspections count, power supply period, and laser application period of the inspection apparatus 1, which increase with use of the inspection apparatus 1; in addition, other indexes are also available. Such examples include the limit of the number of inspections, limit reference values for power supply period, and limit reference values for laser application period, which may be initially set to a counter, and decremented for every use of the inspection apparatus 1.

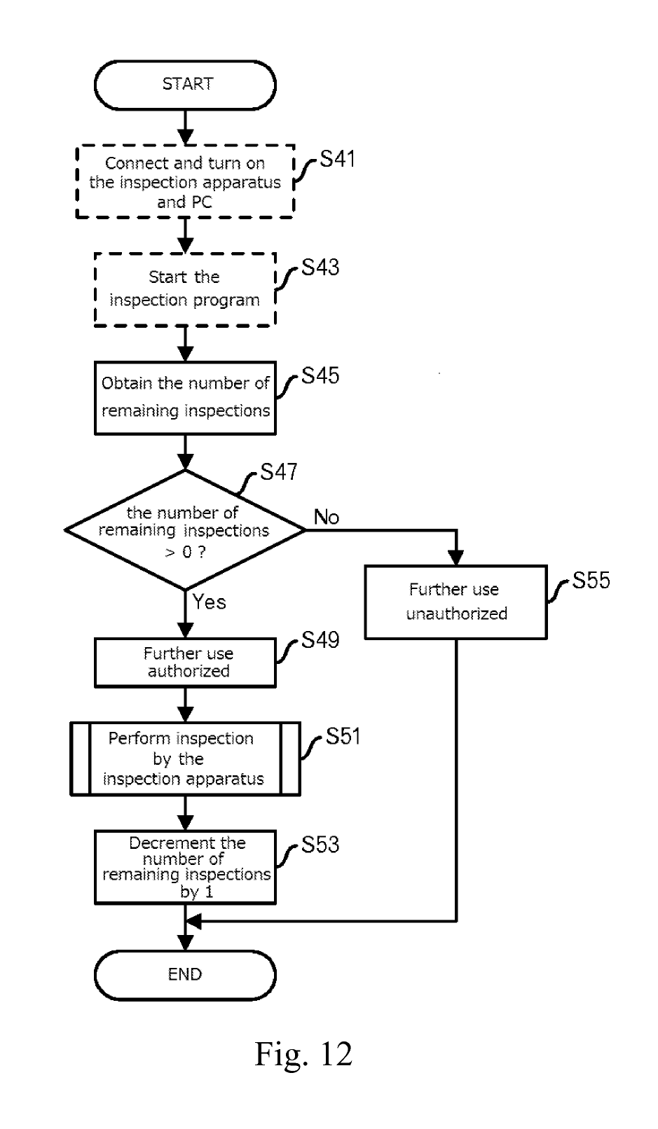

Even with such a technique, the system and configuration shown in FIGS. 1 to 3 are required as in Embodiment 1. In contrast, the process flow is replaced with that as shown in FIG. 12.

First, a user connects the inspection apparatus 1 and the computer 3 via a USB cable, etc. and turns on the power thereto (FIG. 12: step S41). Operations of the user are shown in dotted blocks.

Then, the user confirms that the inspection apparatus 1 has been detected by the computer 3 and starts the inspection program 31 (step S43). The first determination unit 311 of the started inspection program 31 requests and obtains the number of remaining inspections from the inspection apparatus 1 (step S45).

In this embodiment, the inspection apparatus 1 may be connected to a different computer 3; therefore, the memory 15 of the inspection apparatus 1 stores the number of remaining inspections. As stated above, the following relationship holds: the number of remaining inspections=the limit of the number of inspections—the inspections count. This is an example of differences between a reference value and a divergence index correlated to divergence from the state where the inspection apparatus 1 is calibrated; the number of remaining inspections may be replaced with other divergence index values.

Further, the number of remaining inspections may be either a value counted and stored in memory 15 by the control unit 11 of the inspection unit 1, or a value decremented from a previous value by the number of inspections by the inspection processing unit 313 of the inspection program 31 and written in the memory 15 via the I/F 16 by the control unit 11. Still further, in step S45, the first determination unit 311 may merely instruct the control unit of the inspection apparatus 1 to practically read out the number of remaining inspections from the memory 15.

Next, the first determination unit 311 determines whether the number of remaining inspections is greater than zero (step S47). This may be performed by the control unit 11.

When the number of remaining inspections is equal to or smaller than zero, the first determination unit 311 determines that the inspection apparatus 1 cannot be further used and displays a message on the display device of the computer 3 (step S55). The processing is then completed. The first determination unit 311 sets the control unit 11 of the inspection apparatus 1 as being unauthorized for further use. Thus, the inspection of an optical disk by the inspection apparatus 1 is prohibited. When the control unit 11 performs step S7, the determination result is notified to the first determination unit 311, and the first determination unit 311 provides a display on the display device in response to the notification.

On the other hand, when the number of remaining inspections is greater than zero, the first determination unit 311 authorizes the inspection processing unit 313 to further use the inspection apparatus 1 (step S49). That is, the first determination unit 311 sets the control unit 11 of the inspection apparatus 1 and the inspection processing unit 313 as being authorized for further use of the inspection apparatus 1, and provides the display device with a display indicating that the inspection apparatus 1 can be further used. When the control unit 11 performs step S47, the determination result is notified to the first determination unit 311, and the first determination unit 311 provides a display on the display device in response to the notification. The first determination unit 311 authorizes the inspection processing unit 313 to further use the inspection apparatus 1.

Then, the inspection processing unit 313 performs inspection of the optical recording disk 5 by the inspection apparatus 1 in cooperation with the control unit 11 (step S51). The details of step S51 are the same as those described for Embodiment 1 with reference to FIGS. 5 to 11, and thus are omitted here.

The control unit 11, which performs processing for inspection in response to instructions from the inspection processing unit 313, decrements the number of remaining inspections by 1 and stores the number of remaining inspections in the memory 15 (step S53). The processing is then completed.

Thus, the optical disk on which archive data is stored is properly inspected while ensuring that the inspection apparatus is not largely diverged from the calibrated state.

### Embodiment 3

In this embodiment, more detailed inspection is performed on the inspection apparatus 1. The inspection system is in the same configuration as shown in FIG. 1. The inspection apparatus 1 is the same as shown in FIG. 2 except for some differences in operation.

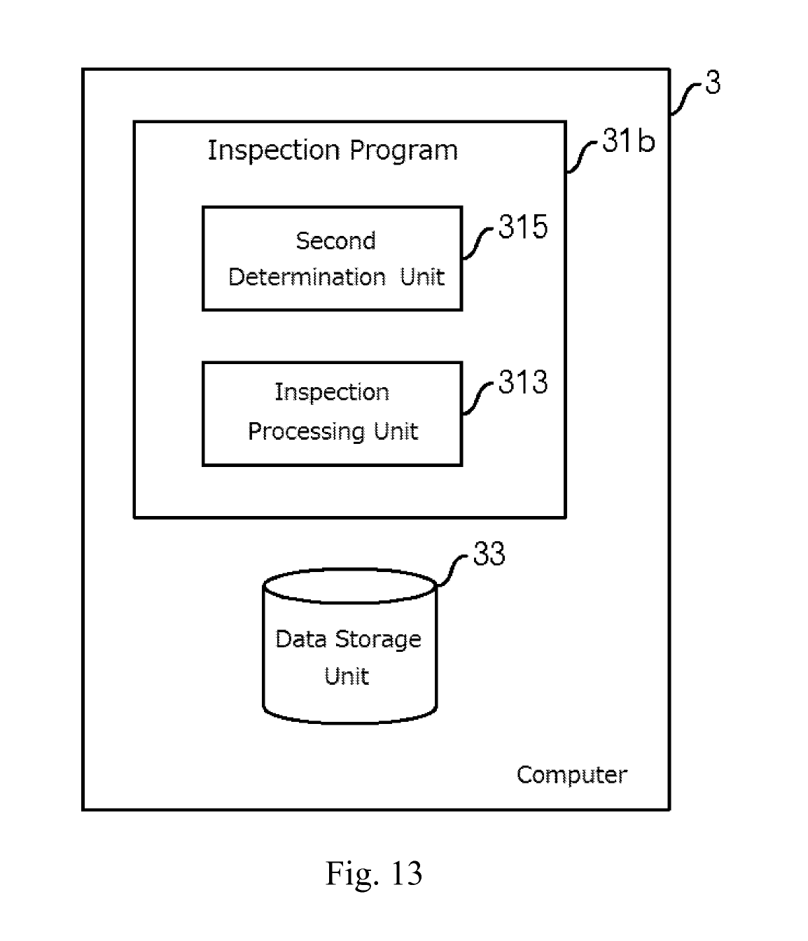

FIG. 13 shows an example of functional configuration of a computer 3 according to this embodiment. The computer 3 runs an inspection program 31b for performing processes according to the embodiment and the computer 3 comprises a data storage unit 33. When the inspection program 31b is run, a second determination unit 315 and an inspection processing unit 313 are implemented. The second determination unit 315 performs a second determination process to determine whether the inspection apparatus 1 can be further used. The inspection processing unit 313 is the same as in Embodiment 1 and performs processes of the inspection apparatus 1 related to inspection.

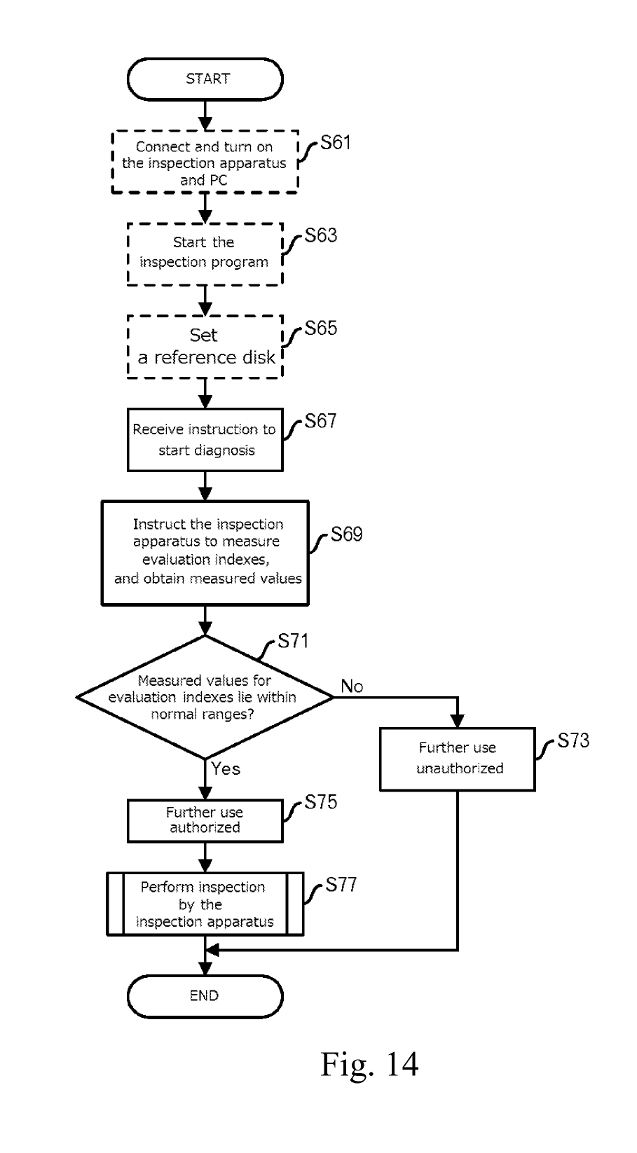

Following is description of the processes of Embodiment 3 with reference to FIG. 14. First, a user connects the inspection apparatus 1 and the computer 3 via a USB cable, etc. and turns on the power thereto (FIG. 14: step S61). Operations of the user are shown in dotted blocks.

Then, the user confirms that the inspection apparatus 1 has been detected by the computer 3 and starts the inspection program 31b (step S63). Further, the user sets a reference disk into the inspection apparatus 1 (step S65).

The reference disk is a calibrating medium used to detect deterioration of inspection characteristics due to aging and mechanical defects of the inspection apparatus 1. The reference disk contains data consisting of a media ID identifying the reference disk or other identification keys; the second determination unit 315 continues the determination process described below if the data is proper, but stops the determination process if the data is improper. On the reference disk, a certain data is recorded in advance to enable measurement of data to be used in the determination process described below. Additionally, reference values to be used in the determination process may also be recorded on the reference disk. Further, the inspection apparatus 1 is provided with a recording function. Only if the reference values to be used in the determination process are set based on characteristic values recorded by the recording function of the inspection apparatus 1, the reference disk may be an optical recording disk including a blank portion.

When receiving an instruction to start a diagnosis from a user (step S67), the second determination unit 315 instructs the inspection apparatus 1 to measure an evaluation index representing a characteristic of reproduced signals to obtain measured values from the inspection apparatus 1 (step S69).

In response to the instruction from the second determination unit 315, the control unit 11 of the inspection apparatus 1 measures characteristic values on the data storage area of the subject disk.

The measured characteristic values include at least any one of, for example, error rate, the number of uncorrectable errors, jitter, and asymmetry value. That is, the control unit 11 calculates these values by using data from the characteristic values sensing unit 13 and the data demodulation circuit 14. More specifically, either one or all of the maximum value, the minimum value, and the average of these characteristic values are calculated. Preferably, the asymmetry value should be calculated to obtain the maximum value and the minimum value, and the other characteristic values should be calculated to obtain the maximum value. The control unit 11 outputs these characteristic values to the second determination unit 315 of the computer 3 via the I/F 16. The second determination unit 315 obtains these measured values.

Then, the second determination unit 315 determines whether the measured values for the evaluation indexes obtained from the inspection apparatus 1 lie within the normal ranges defined by the reference values stored in the data storage unit 33 (step S71). For example, when the maximum value of error rate is measured, the second determination unit 315 determines whether the measured maximum value of error rate is smaller than the reference value defining the upper limit of the maximum value of error rate. For further example, when the maximum value and the minimum value of asymmetry value are measured, the second determination unit 315 determines whether the measured maximum value and the minimum value are between the reference values defining the upper limit and the lower limit. When a plurality of evaluation indexes are combinedly used, the second determination unit 315 determines whether measured values for both evaluation indexes are within the respective normal ranges.

The step S71 may also be implemented by the control unit 11 performing the determination by using reference values stored in the memory 15.

When the measured values for an evaluation index are not within the normal range, the second determination unit 315 determines that the inspection apparatus 1 cannot be further used and provides a display on the display device of the computer 3 (step S73). The processing is then completed. The first determination unit 315 sets the control unit 11 of the inspection apparatus 2 as being unauthorized for further use. Thus, the inspection of an optical disk by the inspection apparatus 1 is prohibited. When the control unit 11 performs step S71, the determination result is notified to the second determination unit 315, and the second determination unit 315 provides a display on the display device in response to the notification.

On the other hand, when the measured values for the evaluation indexes are within the respective normal ranges, the second determination unit 315 authorizes the inspection processing unit 313 to further use the inspection apparatus 1 (step S75). That is, the first determination unit 315 sets the control unit 11 of the inspection apparatus 2 and the inspection processing unit 313 as being authorized for further use of the inspection apparatus 1, and provides the display device with a display indicating that the inspection apparatus 1 can be further used. When the control unit 11 performs step S71, the determination result is notified to the second determination unit 315, and the second determination unit 315 provides a display on the display device in response to the notification. The first determination unit 315 authorizes the inspection processing unit 313 to further use the inspection apparatus 2.

Then, the inspection processing unit 313 performs inspection of the optical recording disk 5 by the inspection apparatus 1 in cooperation with the control unit 11 (step S77). The details of step S77 are the same as those described for Embodiment 1 with reference to FIGS. 5 to 11, and thus are omitted here.

Thus, the optical disk on which archive data is stored is properly inspected while ensuring that the measured values for evaluation indexes measured when the inspection apparatus 1 replays the reference disk are within the respective normal ranges.

### Embodiment 4

This embodiment combines Embodiment 1 and Embodiment 3. The entire inspection system is in the same configuration as shown in FIG. 1. The inspection apparatus 1 is the same as shown in FIG. 2 except for some differences in operation.

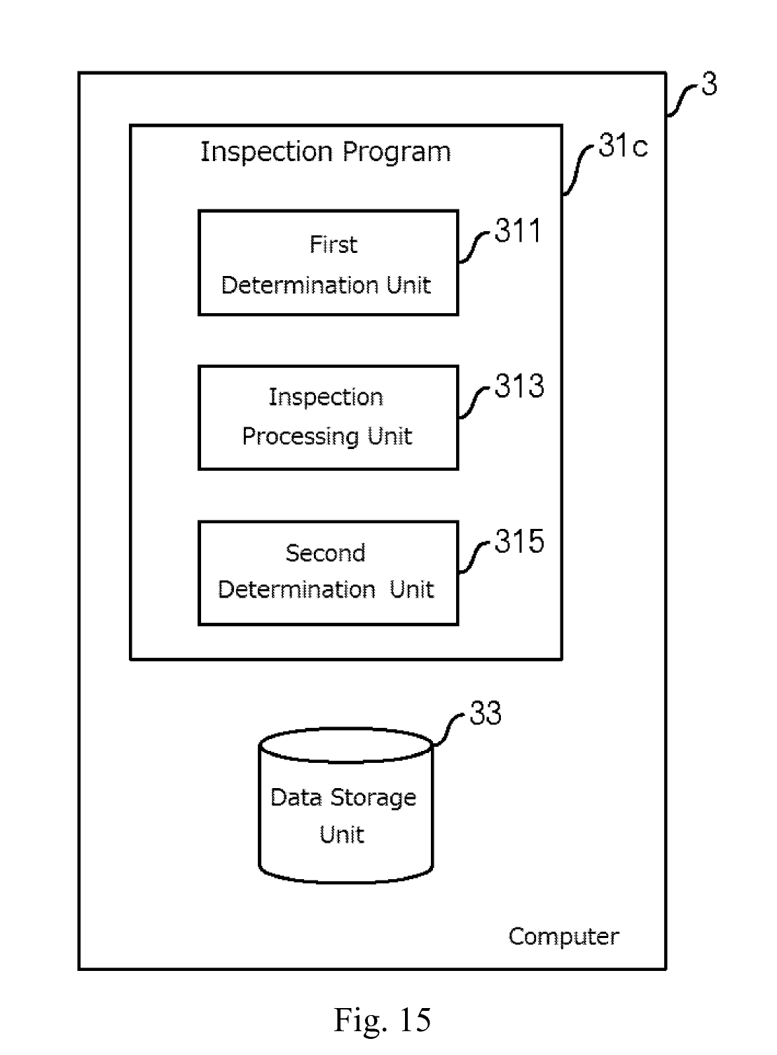

FIG. 15 shows an example of functional configuration of a computer 3 according to this embodiment. The computer 3 runs an inspection program 31c for performing processes according to the embodiment and the computer 3 comprises a data storage unit 33. When the inspection program 31c is run, a first determination unit 311, a second determination unit 315, and an inspection processing unit 313 are implemented. The first determination unit 311 performs a first determination process to determine whether the inspection apparatus 1 can be further used. The second determination unit 315 performs a second determination process to determine whether the inspection apparatus 1 can be further used. The inspection processing unit 313 is the same as in Embodiment 1 and performs processes of the inspection apparatus 1 related to inspection.

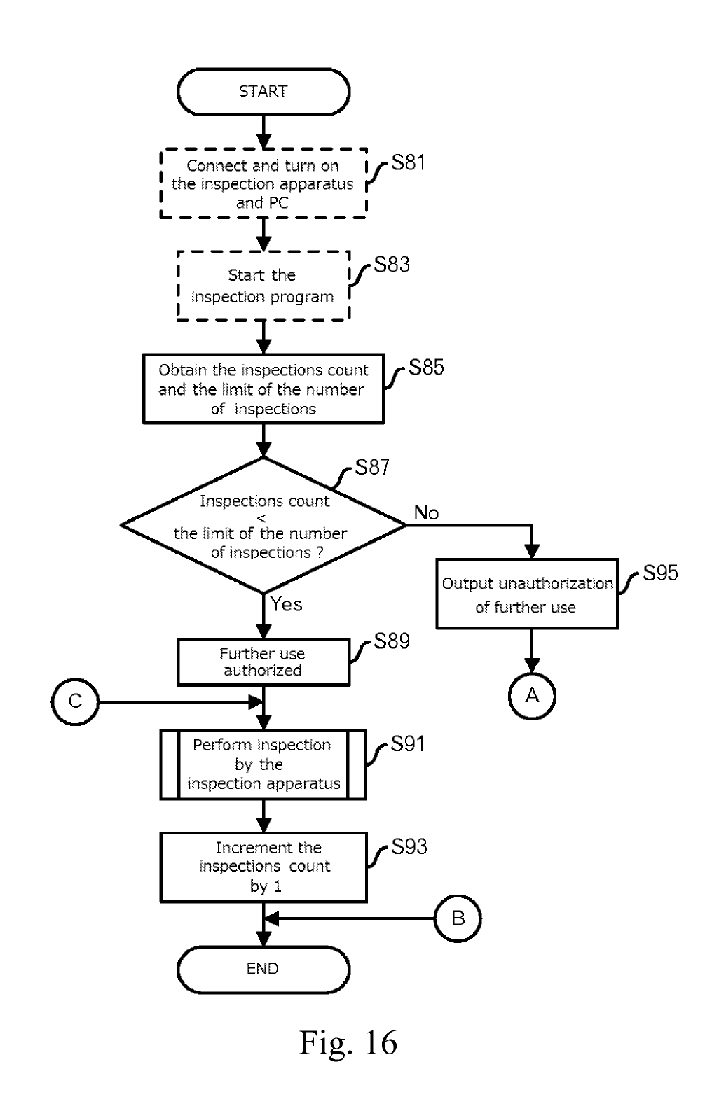

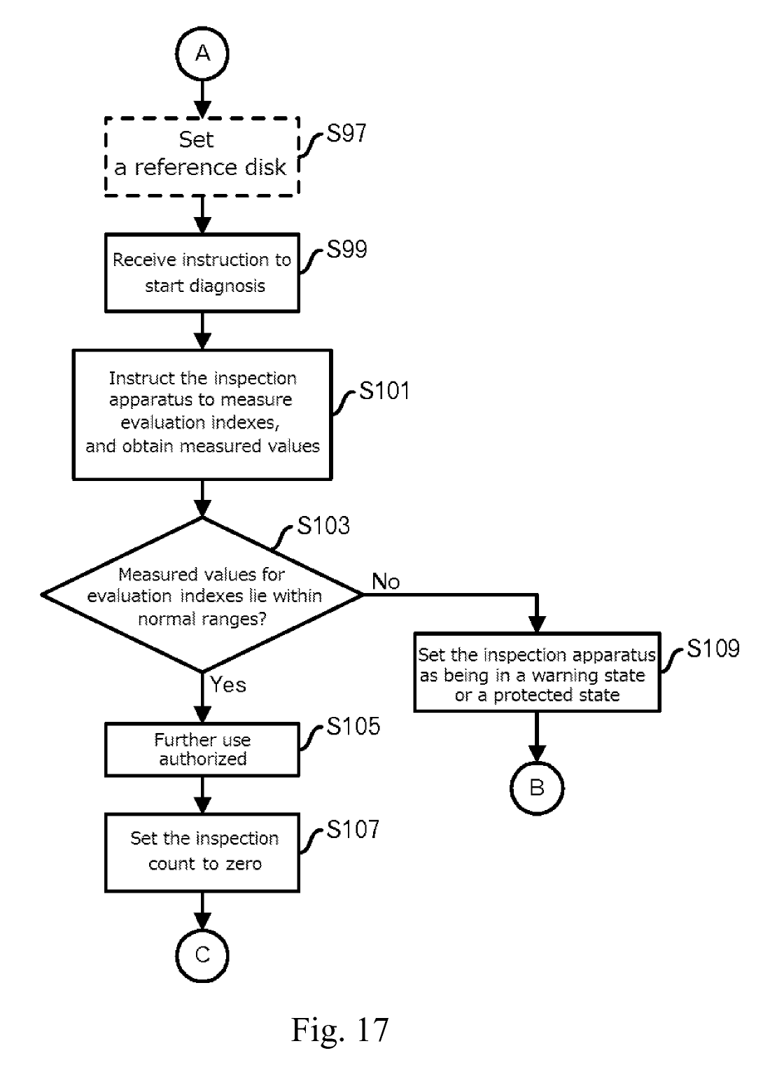

Following is description of the processes of Embodiment 4 with reference to FIGS. 16 and 17.

First, a user connects the inspection apparatus 1 and the computer 3 via a USB cable, etc. and turns on the power thereto (FIG. 16: step S81). Operations of the user are shown in dotted blocks.

Then, the user confirms that the inspection apparatus 1 has been detected by the computer 3 and starts the inspection program 31c (step S83). The first determination unit 311 of the started inspection program 31c requests and obtains, from the inspection apparatus 1, the inspections count and the limit of the number of inspections that is used as a reference value for the inspections count (step S85). The step S85 is the same as the step S5 in Embodiment 1. Also, the inspections count and the limit of the number of inspections are the same as those in Embodiment 1.

Next, the first determination unit 311 determines whether the inspections count is smaller than the limit of the number of inspections (step S87). This step may also be performed by the control unit 11.

When the inspections count is equal to or greater than the limit of the number of inspections, the first determination unit 311 determines that the inspection apparatus 1 cannot be further used and provides a display on the display device of the computer 3 (step S95). The process transitions to the process shown in FIG. 17 through the terminal A.

In this embodiment, even when the further use is unauthorized in step S95, the inspection process on an optical recording disk 5 can be performed if the second determination process described below results successfully. Thus, the setting for unauthorized further use is not immediately required on the inspection apparatus 1, etc.

When the control unit 11 performs step S87, the determination result is notified to the first determination unit 311, and the first determination unit 311 provides a display on the display device in response to the notification.

On the other hand, when the inspections count is smaller than the limit of the number of inspections, the first determination unit 311 authorizes the inspection processing unit 313 to further use the inspection apparatus 1 (step S89). That is, the first determination unit 311 sets the control unit 11 of the inspection apparatus 1 and the inspection processing unit 313 as being authorized for further use of the inspection apparatus 1, and provides the display device with a display indicating that the inspection apparatus 1 can be further used. When the control unit 11 performs step S87, the determination result is notified to the first determination unit 311, and the first determination unit 311 provides a display on the display device in response to the notification. The first determination unit 311 authorizes the inspection processing unit 313 to further use the inspection apparatus 1.

Then, the inspection processing unit 313 performs inspection of the optical recording disk 5 by the inspection apparatus 1 in cooperation with the control unit 11 (step S91). The details of step S91 are the same as those described for Embodiment 1 with reference to FIGS. 5 to 11, and thus are omitted here.

The control unit 11, which performs processing for inspection in response to instructions from the inspection processing unit 313, increments the inspections count by 1 and stores the inspections count in the memory 15 (step S93). The processing is then completed. When other indexes are used in step S87, the values for the indexes are increased in the same manner.

Thus, the optical disk on which archive data is stored is properly inspected while ensuring that the inspection apparatus is not largely diverged from the calibrated state.

Next, transitioning to the processes shown in FIG. 17, the first determination unit 311 provides a display on the display device so as to prompt the user to set the reference disk. In response, the user sets the reference disk into the inspection apparatus 1 (step S97). The reference disk is the same as in Embodiment 3.

When receiving an instruction to start a diagnosis from a user (step S99), the second determination unit 315 instructs the inspection apparatus 1 to measure an evaluation index representing a characteristic of reproduced signals to obtain measured values from the inspection apparatus 1 (step S101).

In response to the instruction from the second determination unit 315, the control unit 11 of the inspection apparatus 1 measures characteristic values on the data storage area of the subject disk. The measured evaluation indexes are the same as in Embodiment 3.

Then, the second determination unit 315 determines whether the measured values for the evaluation indexes obtained from the inspection apparatus 1 lie within the normal ranges defined by the reference values stored in the data storage unit 33 (step S103). This step is the same as step S71 in Embodiment 3 and may also be performed by the control unit 11.

When the measured values for an evaluation index are not within the normal range, the second determination unit 315 determines that the inspection apparatus 1 cannot be further used and sets the inspection apparatus 1 as being in a warning state or a protected state. Further, the second determination unit 315 provides a display on the display device to notify that further use is unauthorized and the inspection apparatus 1 is in a warning state or a protected state (step S109). The processing is then completed.

In response to the determination of unauthorized further use, one of the warning state and the protected state is set for the inspection apparatus 1. When the warning state is set, the measurement function of the control unit 11 of the inspection apparatus 1 is left operable. When the inspection apparatus 1 is to be used for an inspection, an initial warning display or the like prompts the user to redo the calibration. On the other hand, when the protected state is set, the measurement function of the control unit 11 of the inspection apparatus 1 is disabled. This prohibits the inspection apparatus 1 from performing an inspection until properly calibrated.

On the other hand, when the measured values for the evaluation indexes are within the respective normal ranges, the second determination unit 315 authorizes the inspection processing unit 313 to further use the inspection apparatus 1 (step S105). That is, the first determination unit 315 sets the control unit 11 of the inspection apparatus 2 and the inspection processing unit 313 as being authorized for further use of the inspection apparatus 1, and provides the display device with a display indicating that the inspection apparatus 1 can be further used. When the control unit 11 performs step S103, the determination result is notified to the second determination unit 315, and the second determination unit 315 provides a display on the display device in response to the notification. The first determination unit 315 authorizes the inspection processing unit 313 to further use the inspection apparatus 2.

Then, the second determination unit 315 instructs the control unit 11 of the inspection apparatus 1 to initialize the inspections count to zero; and in response to this instruction, the control unit 11 initializes the inspections count to zero (step S107). The process transitions to step S91 in FIG. 16 through the terminal C.

Thus, even if the validation of the inspections count results unsuccessfully, the further use is authorized when the reproduction characteristics for the reference disk are confirmed to ensure sufficient performance.

### Embodiment 5

This embodiment combines Embodiment 2 and Embodiment 3. The entire inspection system is in the same configuration as in Embodiment 1; and the functions of the inspection apparatus 1 are the same as in Embodiment 1. The configuration of the computer 3 is the same as in Embodiment 4.

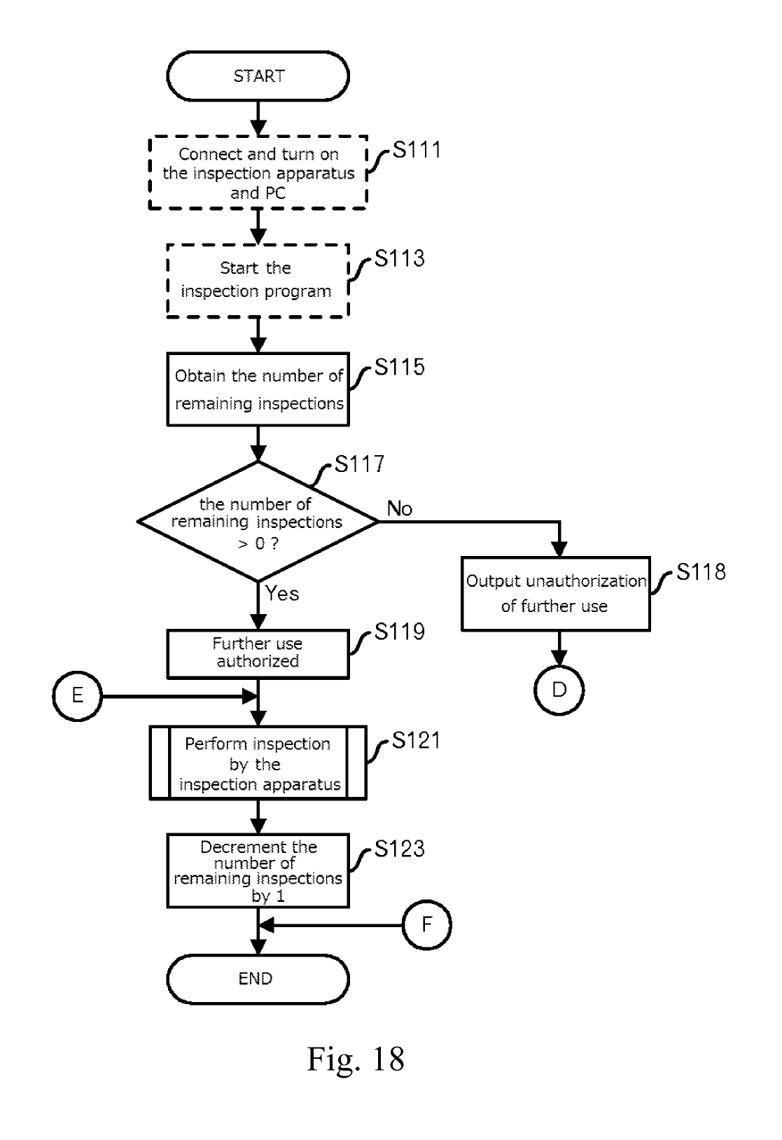

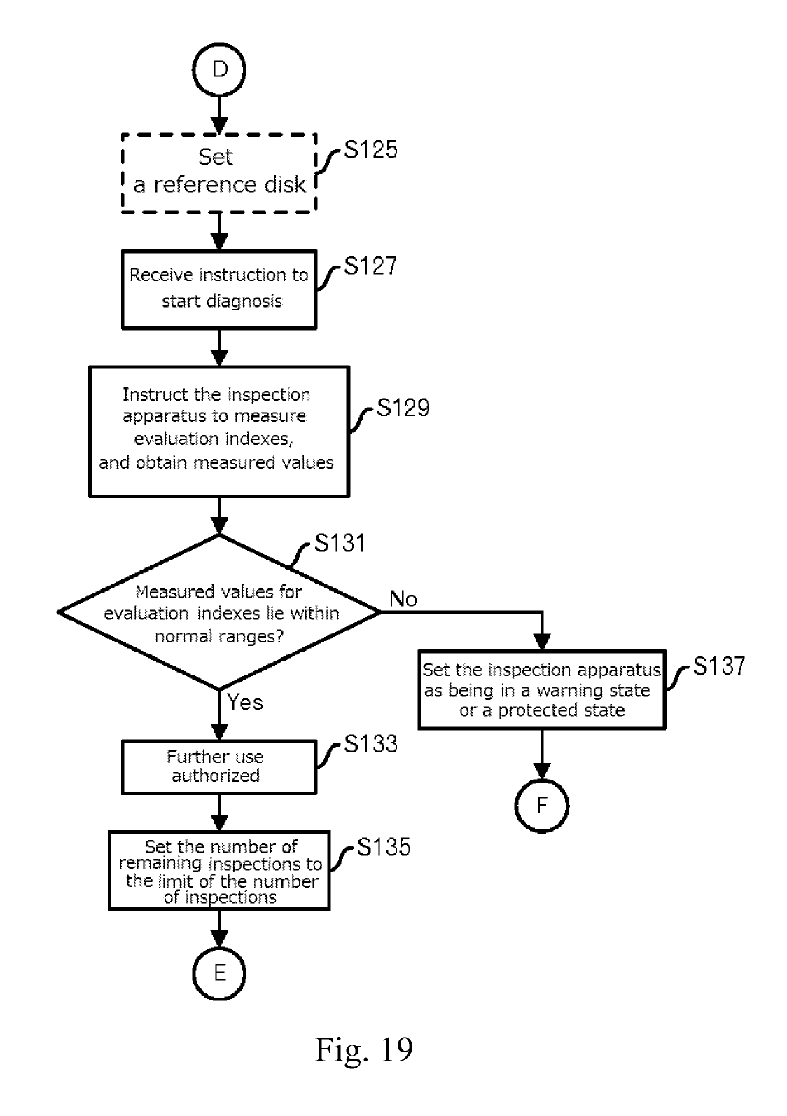

Following is description of the processes of Embodiment 5 with reference to FIGS. 18 and 19.

First, a user connects the inspection apparatus 1 and the computer 3 via a USB cable, etc. and turns on the power thereto (FIG. 18: step S111). Operations of the user are shown in dotted blocks.

Then, the user confirms that the inspection apparatus 1 has been detected by the computer 3 and starts the inspection program 31c (step S113). The first determination unit 311 of the started inspection program 31c requests and obtains the number of remaining inspections from the inspection apparatus 1 (step S115). This step is the same as the step S45 in Embodiment 2.

Next, the first determination unit 311 determines whether the number of remaining inspections is greater than zero (step S117). This may be performed by the control unit 11.

When the number of remaining inspections is equal to or smaller than zero, the first determination unit 311 determines that the inspection apparatus 1 cannot be further used and provides a display on the display device of the computer 3 (step S118). The process transitions to the process shown in FIG. 19 through the terminal D.

In this embodiment, even when the further use is unauthorized in step S118, the inspection process on an optical recording disk 5 can be performed if the second determination process described below results successfully. Thus, the setting for unauthorized further use is not immediately required for the inspection apparatus 1.

When the control unit 11 performs step S117, the determination result is notified to the first determination unit 311, and the first determination unit 311 provides a display on the display device in response to the notification.

On the other hand, when the number of remaining inspections is greater than zero, the first determination unit 311 authorizes the inspection processing unit 313 to further use the inspection apparatus 1 (step S119). That is, the first determination unit 311 sets the control unit 11 of the inspection apparatus 1 and the inspection processing unit 313 as being authorized for further use of the inspection apparatus 1, and provides the display device with a display indicating that the inspection apparatus 1 can be further used. When the control unit 11 performs step S117, the determination result is notified to the first determination unit 311, and the first determination unit 311 provides a display on the display device in response to the notification. The first determination unit 311 authorizes the inspection processing unit 313 to further use the inspection apparatus 1.

Then, the inspection processing unit 313 performs inspection of the optical recording disk 5 by the inspection apparatus 1 in cooperation with the control unit 11 (step S121). The details of step S121 are the same as those described for Embodiment 1 with reference to FIGS. 5 to 11, and thus are omitted here.

The control unit 11, which performs processing for inspection in response to instructions from the inspection processing unit 313, decrements the number of remaining inspections by 1 and stores the number of remaining inspections in the memory 15 (step S123). The processing is then completed.

Transitioning to the processes shown in FIG. 19, the first determination unit 311 provides a display on the display device so as to prompt the user to set the reference disk. In response, the user sets the reference disk into the inspection apparatus 1 (step S125). The reference disk is the same as in Embodiment 3.

When receiving an instruction to start a diagnosis from a user (step S127), the second determination unit 315 instructs the inspection apparatus 1 to measure an evaluation index representing a characteristic of reproduced signals to obtain measured values from the inspection apparatus 1 (step S129).

In response to the instruction from the second determination unit 315, the control unit 11 of the inspection apparatus 1 measures a characteristic value on the data storage area of the subject disk. The measured evaluation indexes are the same as in Embodiment 3.

Then, the second determination unit 315 determines whether the measured values for the evaluation indexes lie within the normal ranges defined by the reference values stored in the data storage unit 33 (step S131). This step may also be performed by the control unit 11 as in step S71 in Embodiment 3.

When the measured values for an evaluation index are not within the normal range, the second determination unit 315 determines that the inspection apparatus 1 cannot be further used and sets the inspection apparatus 1 as being in a warning state or a protected state. Further, the second determination unit 315 provides a display on the display device to notify that further use is unauthorized and the inspection apparatus 1 is in a warning state or a protected state (step S137). The processing is then completed. This step is the same as the step S109 in Embodiment 4.

On the other hand, when the measured values for the evaluation indexes are within the respective normal ranges, the second determination unit 315 authorizes the inspection processing unit 313 to further use the inspection apparatus 1 (step S133). That is, the first determination unit 315 sets the control unit 11 of the inspection apparatus 2 and the inspection processing unit 313 as being authorized for further use of the inspection apparatus 1, and provides the display device with a display indicating that the inspection apparatus 1 can be further used. When the control unit 11 performs step S131, the determination result is notified to the second determination unit 315, and the second determination unit 315 provides a display on the display device in response to the notification. The first determination unit 315 authorizes the inspection processing unit 313 to further use the inspection apparatus 2.

Then, the second determination unit 315 instructs the control unit 11 of the inspection apparatus 1 to initialize the number of remaining inspections to the limit of the number of inspections used as a reference value; and in response to this instruction, the control unit 11 initializes the number of remaining inspections to the limit of the number of inspections (step S135). The process transitions to step S121 in FIG. 18 through the terminal E.

Thus, even if the validation of the inspections count results unsuccessfully, the further use is authorized when the reproduction characteristics for the reference disk are confirmed to ensure sufficient performance.

### Embodiment 6

This embodiment is an example of modifications of Embodiment 5. The configuration of the system is the same as in Embodiment 5.

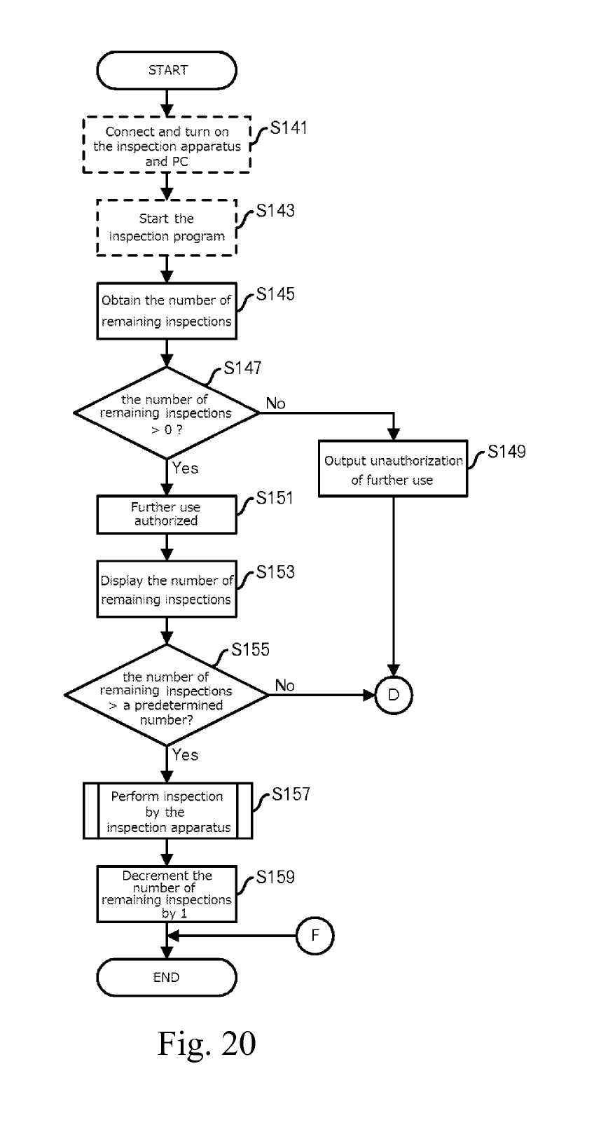

The process flow is modified into that as shown in FIG. 20.

First, a user connects the inspection apparatus 1 and the computer 3 via a USB cable, etc. and turns on the power thereto (FIG. 20: step S141). Operations of the user are shown in dotted blocks.

Then, the user confirms that the inspection apparatus 1 has been detected by the computer 3 and starts the inspection program 31c (step S143). The first determination unit 311 of the started inspection program 31c requests and obtains the number of remaining inspections from the inspection apparatus 1 (step S145). This step is the same as the step S45 in Embodiment 2.

Next, the first determination unit 311 determines whether the number of remaining inspections is greater than zero (step S147). This may be performed by the control unit 11.

When the number of remaining inspections is equal to or smaller than zero, the first determination unit 311 determines that the inspection apparatus 1 cannot be further used and provides a display on the display device of the computer 3 (step S149). The process transitions to the process shown in FIG. 19 through the terminal D. The subsequent steps are the same as in Embodiment 5.

When the control unit 11 performs step S147, the determination result is notified to the first determination unit 311, and the first determination unit 311 provides a display on the display device in response to the notification.

On the other hand, when the number of remaining inspections is greater than zero, the first determination unit 311 authorizes the inspection processing unit 313 to further use the inspection apparatus 1 (step S151). That is, the first determination unit 311 sets the control unit 11 of the inspection apparatus 1 and the inspection processing unit 313 as being authorized for further use of the inspection apparatus 1, and provides the display device with a display indicating that the inspection apparatus 1 can be further used. When the control unit 11 performs step S147, the determination result is notified to the first determination unit 311, and the first determination unit 311 provides a display on the display device in response to the notification. The first determination unit 311 authorizes the inspection processing unit 313 to further use the inspection apparatus 1.

Then, the first determination unit 311 displays the number of remaining inspections on the display device (step S153) to inform the user of the current state. Next, the first determination unit 311 determines whether the number of remaining inspections is greater than a predetermined number (step S155). In this embodiment, the process in FIG. 19 should be performed to confirm the inspection performance of the inspection apparatus 1 as previously as possible, for example, when the number of remaining inspections is about 20, not zero. This enables actions before the inspection apparatus 1 is in the warning state or in the protected state.

Accordingly, when the number of remaining inspections are smaller than a predetermined number, the process transitions to the steps in FIG. 19 through the terminal D after, e.g., confirmation to the user. Also, the process may automatically transition to the steps in FIG. 19.

On the other hand, when the number of remaining inspections is equal to or greater than the predetermined number, the inspection processing unit 313 performs inspection of the optical recording disk 5 by the inspection apparatus 1 in cooperation with the control unit 11 (step S157). The details of step S157 are the same as those described for Embodiment 1 with reference to FIGS. 5 to 11, and thus are omitted here.

The control unit 11, which performs processing for inspection in response to instructions from the inspection processing unit 313, decrements the number of remaining inspections by 1 and stores the number of remaining inspections in the memory 15 (step S159). The processing is then completed.

Through the above process, the inspection apparatus 1 to be used is kept previously checked for the inspection performance and is not suddenly disabled.

Embodiment 5 can be modified in the same manner as this embodiment.

The embodiments described above do not limit the present invention. For example, the functional block configuration of the computer 3 is a mere example, and does not necessarily correspond to the actual program module configuration. Also, in the process flow, the steps may be reordered or arranged in parallel as long as the result of the process is kept unchanged.

Further, the allotment of the functions of the inspection system may be varied and is not limited to the above examples. The warning state or the protected state may be selectively set every time it is determined that a reference is not satisfied.

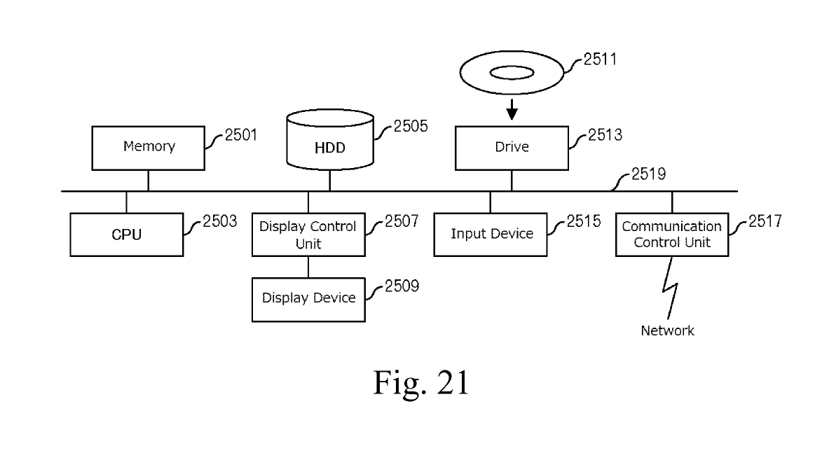

The computer 3 described above is a computer device and comprises, as shown in FIG. 21: a memory 2501; a central processing unit (CPU) 2503; a hard disk drive (HDD) 2505; a display control unit 2507 connected to a display device 2509; a drive 2513 for a removable disk 2511; an input device 2515; and a communication control unit 2517 to be connected to a network. These components are connected via a bus 2519. An operating system (OS) and application programs for performing the processes of the embodiments are stored on the HDD 2505 and are read out from the HDD 2505 into the memory 2501 to be executed by the CPU 2503. The CPU 2503 controls and operates the display control unit 2507, the communication control unit 2517, and the drive 2513 in accordance with the content of the processes of the application programs. Further, the data under processing is stored mainly in the memory 2501 but may be alternatively stored in the HDD 2505. In the embodiments of the present invention, the application programs for performing the above processes are stored on the computer-readable removable disk 2511 and distributed, and installed from the drive 2513 onto the HDD 2505. The application programs may be installed on the HDD 2505 through a network such as the Internet and the communication control unit 2517. In such a computer device, hardware including the CPU 2503 and the memory 2501, and programs including the OS and the application programs organically cooperate with each other to implement the various functions described above.

What is claimed is:

1. A determination method comprising the steps of:
determining whether an inspection apparatus for inspecting recording conditions of an optical recording disk can be further used based on a divergence index correlated to divergence from a state where the inspection apparatus is calibrated or on a difference between the divergence index and a reference value of the divergence index; and
if it is determined that the inspection apparatus can be further used, setting authorization for inspecting the optical recording disk by the inspection apparatus.

2. The determination method of claim 1, further comprising the steps of:
if it is determined that the inspection apparatus cannot be further used, obtaining at least one evaluation index out of error rate, the number of uncorrectable errors, jitter, and asymmetry value from reproduction signals of a reference disk; and
if the at least one evaluation index is within a predetermined range, setting authorization for inspecting the optical recording disk by the inspection apparatus.

3. The determining method of claim 2, further comprising the step of:
if the at least one evaluation index is within a predetermined range, initializing the divergence index held in the inspection apparatus.

4. The determination method of claim 1, further comprising the steps of:
if it is determined that the inspection apparatus can be further used, determining whether the divergence index or the difference between the divergence index and the reference value of the divergence index satisfies a predetermined condition before satisfying the condition by which it is determined that the inspection apparatus cannot be further used;
if it is determined that the predetermined condition is satisfied, obtaining at least one evaluation index out of error rate, the number of uncorrectable errors, jitter, and asymmetry value from reproduction signals of the optical recording disk;
if the at least one evaluation value is within a predetermined range, setting authorization for inspecting the optical recording disk by the inspection apparatus.

5. The determination method of claim 1, further comprising the steps of:
if it is determined that the inspection apparatus can be further used, obtaining at least one evaluation index out of error rate, the number of uncorrectable errors, jitter, and asymmetry value from reproduction signals of the optical recording disk;
determining recording conditions of the optical recording disk based on the at least one evaluation index and storing a determination result in a data storage unit.

6. The determination method of claim 1, further comprising the step of:
if it is determined that the inspection apparatus cannot be further used, setting unauthorization for inspecting the optical recording disk by the inspection apparatus.

7. The determination method of claim 2, further comprising the step of:
if the at least one evaluation value is not within the predetermined range, setting unauthorization for inspecting the optical recording disk by the inspection apparatus.

8. The determination method of claim 1, further comprising the step of:
if it is determined that the inspection apparatus cannot be further used, providing a display on a display device indicating that the inspection apparatus is in a warning state.

9. The determination method of claim 2, further comprising the step of:
if the at least one evaluation index is not within the predetermined range, providing a display on a display device indicating that the inspection apparatus is in a warning state.

10. A medium containing a program for causing a computer to perform the determination method of claim 1.

11. An inspection apparatus for inspecting recording conditions of an optical recoding disk, comprising:
a unit contained in the inspection apparatus and configured to determine whether the inspection apparatus can be further used based on a divergence index correlated to divergence from a state where the inspection apparatus is calibrated or on a difference between the divergence index and a reference value of the divergence index; and
a unit configured to set, if it is determined that the inspection apparatus can be further used, authorization for inspecting the optical recording disk by the inspection apparatus.

12. An inspection system comprising:
a unit configured to determine whether an inspection apparatus for inspecting recording conditions of an optical recording disk can be further used based on a divergence index correlated to divergence from a state where the inspection apparatus is calibrated or on a difference between the divergence index and a reference value of the divergence index; and
a unit configured to perform, if it is determined that the inspection apparatus can be further used, an inspection of the optical recording disk by the inspection apparatus.
